(19) United States
(12) Patent Application Publication
(10) Pub. No.: US 2005/0065020 A1
(43) Pub. Date: Mar. 24, 2005

(54) Ionic liquids containing secondary hydroxyl-groups and a method for their preparation

(75) Inventors: John D. Holbrey, Tuscaloosa, AL (US); Megan B. Turner, Tuscaloosa, AL (US); Robin D. Rogers, Tuscaloosa, AL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: UNIVERSITY OF ALABAMA, Tuscaloosa, AL (US)

(21) Appl. No.: 10/934,386

(22) Filed: Sep. 7, 2004

Related U.S. Application Data
(60) Provisional application No. 60/500,228, filed on Sep. 5, 2003.

(51) Int. Cl. B01J 31/00

(52) U.S. Cl. 502/162; 502/167; 502/170; 502/172

(57) ABSTRACT

The invention provides ionic liquids having a secondary hydroxyl group, and an atom-efficient method for the preparation of these ionic liquids, by epoxidation of a protonated nitrogen-containing organic base (which can optionally be prepared in situ) in the presence of an anion suitable for supporting ionic liquid formation.

### REFERENCE TO PRIOR APPLICATION

This application claims the benefit of U.S. Provisional Application No. 60/500,228, filed Sep. 5, 2003. U.S. Provisional Application No. 60/500,228, is incorporated herein, in its entirety, by reference.

### FIELD OF THE INVENTION

This invention relates to ionic liquid (IL) materials comprising an organic cation, which has secondary hydroxyl functionality, and an anion, as well as an atom-efficient method for preparing these ionic liquids.

### DISCUSSION OF THE BACKGROUND

Ionic Liquids (ILs) are low-melting organic salts (usually defined as having a melting point a 100-150° C.). ILs typically contain low-symmetry quaternized, alkyl-substituted, aliphatic or heterocyclic cations. The access to this range of new fluids, that are entirely ionic and have wide liquid ranges, yet are non-volatile and have potentially tunable properties, has lead to the explosion of recent interest, particularly as solvents for electrochemical, synthetic, catalytic and separations applications.^{1,2}

ILs derived from naturally occurring choline chloride (vitamin B4)³, containing an alcohol function close to the charge-carrying core of the cation, have been described. The feasibility of stabilizing enzymatic catalysts, in ILs, by providing a more water-like, or at least hydroxyl-rich microenvironment, without losing the potential solvent properties and benefits of an IL system,⁴ make the introduction of hydroxyl-groups into other ILs an attractive possibility.

Most synthetic procedures to prepare ILs feature initial alkylation of N-containing organic bases (amines and N-heterocycles) with alkylhalides, followed by metathesis to exchange the anion. Efficient, waste-free processes to afford quaternized cations and introduction of the desired anion for IL formation, without salt-forming metatheses, have been achieved using alternative alkylating agents,⁵⁻⁶ or by one-pot syntheses of IL salts,⁷ but have not displaced the conventional methodologies.

The reaction of imidazole with propylene oxide and with other oxides, has been previously described.⁸ Efficient formation of 1-(2-hydroxypropyl)imidazole has been reported at room temperature after 17 h, however, with other substituted imidazoles or epoxides, poorer yields and more vigorous reaction conditions are required. Coupling reactions, most notably utilizing epichlorohydrin to immobilize imidazolium functions have also been widely reported for the preparation of ion-exchangers, dye-fixatives, and antistatic agents.⁹ It should also be noted that imidazole is used as a catalyst for the curing of epoxy-resins.10 Arnold and co-workers¹¹ have described silver and copper carbene complexes containing alkoxide functions, formed with a diimidazolium precursor prepared by treating 1-tert-butylimidazole with a functionalized epichlorohydrin. Coupling of N-alkylimidazoles with chiral styrene epoxide¹² and epoxycyclohexane¹³ have also been reported under microwave conditions as precursors to crystalline imidazolium salts (prepared by subsequent methylation with methyl iodide) and carbene ligands for metal complexation, however the application of these systems to the formation of liquid salts has not, to the best of knowledge, previously been exploited.

### SUMMARY OF THE INVENTION

It is an object of the invention to provide ionic liquid materials containing an organic cation which has secondary hydroxyl functionality on one or more atoms of the cation.

It is another object of the invention to provide ionic liquids materials containing an N-(2-hydroxyalkyl) substituent.

It is another object of the invention to provide a process for the preparation of ionic liquid materials containing an organic cation which has secondary hydroxyl functionality on one or more atoms of the cation.

It is another object of the invention to provide a process for the preparation of ionic liquid materials containing an N-(2-hydroxyalkyl) substituent.

It is another object of the invention to provide a process for the preparation of ionic liquid materials containing an organic cation which has secondary hydroxyl functionality on one or more atoms of the cation, by an atom-efficient coupling of an epoxide with an N-protonated nitrogen base.

It is another object of the invention to provide a process for the preparation of ionic liquid materials containing an N-(2-hydroxyalkyl) substituent, by an atom-efficient coupling of an epoxide with an N-protonated nitrogen base.

It is another object of the invention to provide a process for the preparation of ionic liquid materials containing an organic cation which has secondary hydroxyl functionality on one or more atoms of the cation, by an atom-efficient coupling of an epoxide with an N-protonated nitrogen base prepared in situ by neutralization of the base with an acid.

It is a further object of the present invention to provide a process for the preparation of ionic liquid materials containing an N-(2-hydroxyalkyl) substituent, by an atom-efficient coupling of an epoxide with a an N-protonated nitrogen base, prepared in situ by neutralization of the base with an acid.

These and other objects of the present invention have been satisfied, either individually or in combinations thereof, by the discovery of an ionic liquid represented by formula (1),
[R′CH(OH)CH₂]NRₙX (1),
wherein [R′CH(OH)CH₂]NRₙ represents a cation and X represents an anion, and
R′ represents an alkyl group, an alkenyl group, an alkynyl group, a cycloalkyl group, an alkylcarbonyl alkyl group, an alkoxy group, a haloalkyl group, a haloalkoxy group, a alkenyloxy group, a alkynyloxy group, a cycloalkyloxy group, or an aryl group, and by the methods of producing the same.

### BRIEF DESCRIPTION OF THE FIGURE

A more complete appreciation of the invention, and many of the attendant advantages thereof, will be readily obtained, as the same becomes better understood by reference to the following detailed description, when considered in connection with the accompanying drawings, wherein:

FIG. 1 is a graphical representation showing decomposition profiles for preferred 1-(2-hydroxypropyl)-3-methylimidazolium ILs determined by TGA.

### DETAILED DESCRIPTION OF THE PREFERRED EMBODIMENTS

The present invention comprises ionic liquids containing an N-(2-hydroxyalkyl) substituent on the cation of the general form:
[R′CH(OH)CH₂]NRₙX (1),
wherein [R′CH(OH)CH₂]NRₙ represents a cation and X represents an anion, and
R′ represents an alkyl group, an alkenyl group, an alkynyl group, a cycloalkyl group, an alkylcarbonyl alkyl group, an alkoxy group, a haloalkyl group, a haloalkoxy group, a alkenyloxy group, a alkynyloxy group, a cycloalkyloxy group, or an aryl group, and by the methods of producing the same.

The invention also provides for the formation of the corresponding ionic liquid salts by the reaction of an organic base (N-containing) with an acid of the formula HₙX, and an epoxide of the general formula, R′CHOCH₂, in which an appropriate anion (X) for support of ionic liquid phase formation is introduced directly through selection of the acid.

The ionic liquids described in the invention display wide liquidus ranges, high thermal stability, and low volatility. These properties are considered important characteristics of ionic liquids. The properties of these ionic liquids differ from those of conventional ionic liquids, as described in the literature, in non-obvious ways, as a result of the incorporation of the pendant hydroxyl group, and result in ionic liquids that have only partial miscibility with dichloromethane and acetone, and in the formation of hydrophilic hexafluorophosphate ionic liquids.

Ionic liquids, containing a N-(2-hydroxyalkyl) substituent, can be prepared by the atom-efficient coupling of the epoxide, propylene oxide, with an N-protonated nitrogen base, prepared in situ by neutralization of the base with an acid. The choice of acid dictates the resultant anion of the IL prepared and thus can be used to prepare ILs in high purity, with no waste, and without requiring further metathetical anion exchange steps.

The addition of the N-(2-hydroxyalkyl) substitutent into the IL cation introduces novel solvent properties, including limited co-miscibility with acetone and with dichloromethane, that are not characteristic of other classes of ionic liquid.

The present invention provides ionic liquids containing a secondary hydroxyl functionality on one, or more, of the hetero-atom substituents of the ionic liquid cation. In particular, some ionic liquids provided by the invention include 1-(2-hydroxypropyl)-3-methylimidazolium chloride, 1-(2-hydroxypropyl)-3-methylimidazolium nitrate, 1-(2-hydroxypropyl)-3-methylimidazolium hexafluorophosphate, 1-(2-hydroxypropyl)-3-methylimidazolium bis(trifluoromethanesulfonyl)imide.

The invention provides ionic liquids represented by general formula (1)
[R′CH(OH)CH₂]NRₙX (1),
wherein [R′CH(OH)CH₂]NRₙ represents a cation and X represents an anion, and
R′ represents an alkyl group, an alkenyl group, an alkynyl group, a cycloalkyl group, an alkylcarbonyl alkyl group, an alkoxy group, a haloalkyl group, a haloalkoxy group, a alkenyloxy group, a alkynyloxy group, a cycloalkyloxy group, or an aryl group.

In particular, R′ represents a C₁-C₂₀ alkyl group, a C₁-C₂₀ alkylcarbonyl C₁-C₂₀ alkyl group, a C₂-C₂₀ alkenyl group, a C₂-C₂₀ alkynyl group, a C₃-C₆ cycloalkyl group, C₁-C₂₀ alkylcarbonyl C₁-C₂₀ alkyl group, a C₁-C₂₀ haloalkyl group, a C₁-C₂₀ alkoxy group, a C₁-C₂₀ haloalkoxy group, a C₂-C₂₀ alkenyloxy group, a C₂-C₂₀ alkynyloxy group, a C₃-C₆ cycloalkyloxy group, or an aryl group.

It is noted that the ranges of carbon atoms, as listed above, include all ranges of carbon atoms within the respective ranges. For example, a C₁-C₂₀ range includes 1, 2, 3, 4, 5, 6, 7, 8, 9, 10, 11, 12, 13, 14, 15, 16, 17, 18, 19 and 20 carbon atoms. In addition, within each range of three or more carbon atoms, linear and branched structures are included. It is also noted, that where appropriate, the general representations and specific representations of the above groups may also be substituted with additional chemical moieties, including, but not limited to, halogen atom, an alkyl group, an alkoxy group, a haloalkyl group, and a haloalkoxy group.

In one embodiment of the invention, the cation is selected from a low-symmetry quaternized, alkyl-substituted aliphatic or heterocyclic cation. In another embodiment, the cation is a low-symmetry quaternized, alkyl-substituted heterocyclic cation, and the heterocyclic group contains one or more substituted heteroatoms. In yet another embodiment, the ionic liquid contains secondary hydroxyl functionality on one or more hetero-atom substituents of a low-symmetry quaternized, alkyl-substituted heterocyclic cation, containing one or more substituted heteroatoms.

It is noted that substitution, where appropriate, may include one or more additional substitutions to the above “[R′CH(OH)CH₂]NRₙ” group. These additional substituents may occur on one or more respective heteroatoms, or on one or more carbon atoms, within the cation. Additional substituents include, but are not limited to, a hydroxyalkyl group, an alkyl group, an alkenyl group, an alkynyl group, an cycloalkyl group, an alkylcarbonyl alkyl group, an alkoxy group, a haloalkyl group, a haloalkoxy group, a alkenyloxy group, a alkynyloxy group, a cycloalkyloxy group, or an aryl group.

In particular, additional substituents include a C₁-C₂₀ hydroxyalkyl group, a C₁-C₂₀ alkyl group, a C₁-C₂₀ alkylcarbonyl C₁-C₂₀ alkyl group, a C₂-C₂₀ alkenyl group, a C₂-C₂₀ alkynyl group, a C₃-C₆ cycloalkyl group, C₁-C₂₀ alkylcarbonyl C₁-C₂₀ alkyl group, a C₁-C₂₀ haloalkyl group, a C₁-C₂₀ alkoxy group, a C₁-C₂₀ haloalkoxy group, a C₂-C₂₀ alkenyloxy group, a C₂-C₂₀ alkynyloxy group, a C₃-C₆ cycloalkyloxy group, or an aryl group.

It is noted that the ranges of carbon atoms, as listed above, include all ranges of carbon atoms within the respective ranges. For example, a C₁-C₂₀ range includes 1, 2, 3, 4, 5, 6, 7, 8, 9, 10, 11, 12, 13, 14, 15, 16, 17, 18, 19 and 20 carbon atoms. In addition, within each range of three or more carbon atoms, linear and branched structures are included. It is also noted, that where appropriate, the general representations and specific representations of the above groups may also be substituted with additional chemical moieties, including, but not limited to, a halogen atom, a hydroxy group, an alkyl group, an alkoxy group, a haloalkyl group, and a haloalkoxy group.

In a preferred embodiment, the cation [R′CH(OH)CH₂]NRₙ of the present invention ionic liquid is preferably cyclic and corresponds in structure to a formula selected from the group consisting of 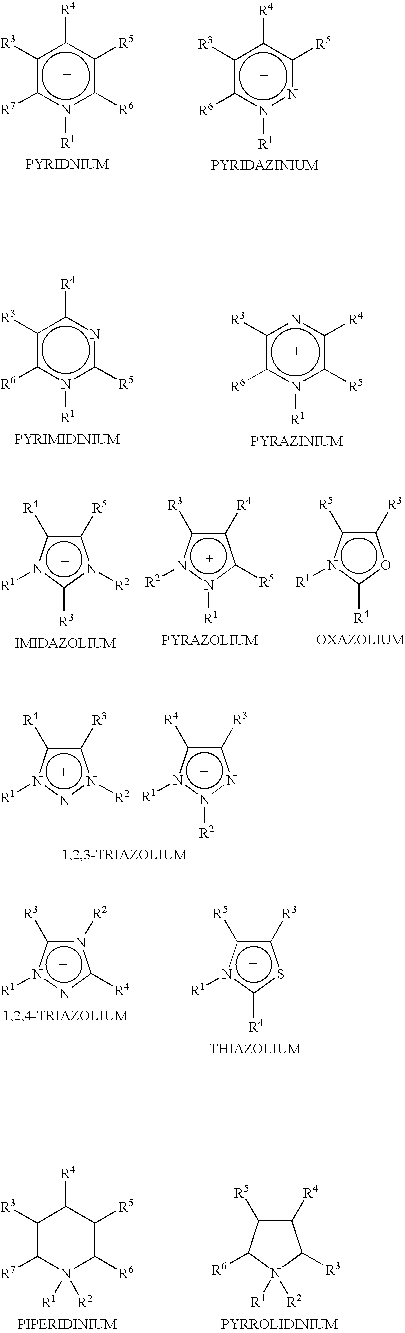 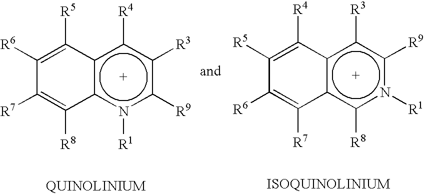
wherein R¹ and R² are independently a C₁-C₆ alkyl group or a C₁-C₆ alkoxyalkyl group, and at least one of R¹ or R² is the group [R′CH(OH)CH₂], and R³, R⁴, R⁵, R⁶, R⁷, R⁸ and R⁹ (R³-R⁹), when present, are each, independently, a hydrido, a C₁-C₆ alkyl, a C₁-C₆ alkoxyalkyl group or a C₁-C₆ alkoxy group. The anion of the present invention ionic liquid is preferably halogen, pseudohalogen, or C₁-C₆ carboxylate. It is to be noted that there are two isomeric 1,2,3-triazoles. It is most preferred that all R groups not required for cation formation be hydrido.

A cation that contains a single five-membered ring that is free of fusion to other ring structures is more preferred. Exemplary cations are illustrated below wherein R¹, R², and R³-R⁵, when present, are as defined before.

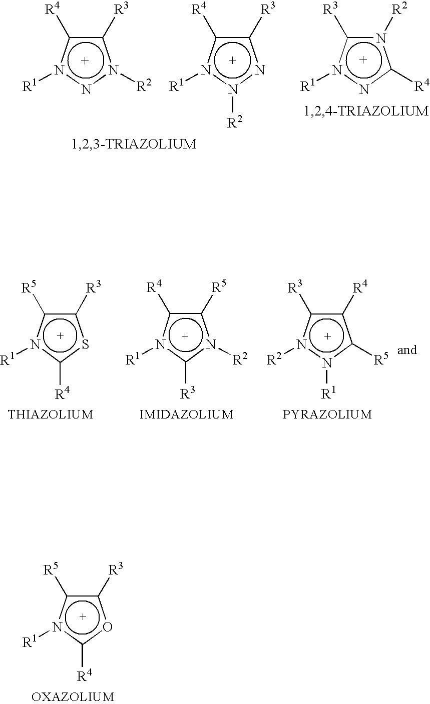

Of the more preferred cations that contain a single five-membered ring free of fusion to other ring structures, an imidazolium cation that corresponds in structure to Formula A is particularly preferred, wherein R¹, R², and R³-R⁵, are as defined before. 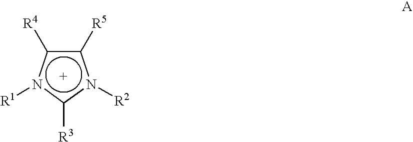
1-(2-Hydroxypropyl)-3-alkylimidazolium cations are most preferred.

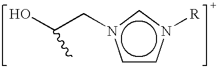

In a preferred embodiment, the anion, X, represents a halide; a nitrate; a borate, such as a fluoroborate or an aryl borate; an amide, such as a perfluorosulfonylimide; a sulfonate, such an alkyl sulfonate or a fluoroalkylsulfonate; a sulfate, such as an alkylsulfate; an imide, such as a fluoromethylsulfonyl imide; a phosphate, such as a fluorophosphates or a fluoroalkyl trifluorophosphate; a tosylate, an antimonite or a carboxylate. It is noted that within the noted anions, alkyl groups, include, but are not limited to methyl, ethyl, propyl (linear and branched) and butyl (linear and branched).

In particular, anions include, but are not limited to, chloride, bromide, iodide, fluoride, nitrate, triphenylborate, tetrafluoroborate, trifluoromethyltrifluoroborate, bis[oxalato(2-)]-borate, bis[salicylato(2-)]-borate, hexafluorophosphate, tris(perfluoroethyl)trifluorophosphate, tris(pentafluoroethyl)trifluorophosphate, methylsulfate, ethylsulfate, trifluoromethanesulfonate, trifluoromethylsulfonate, bis(trifyl)amide, bis(trifluoromethyl)imide, or bis(trifluoromethylsulfonyl)imide.

Materials are prepared in a simple, atom-efficient, and waste free process by alkylation of protonated salt of an organic base with an epoxide, as shown below in representative Reaction 1. The protonated organic salt made be preformed, or may by prepared in situ by neutralization of an organic base with a protic acid. The anion of the resultant salt is provided by the initial acid used. By selection of appropriate acids, in combination with the formation of different cations, ionic liquids containing specific cation/anion combinations can be synthesized in a simple, efficient process from readily available reagents.

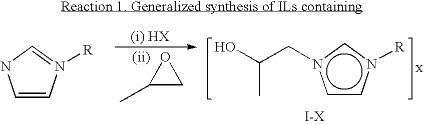

1-(2-hydroxypropyl)-3-methylimidazolium cations by reaction of 1-methylimidazole with acid and propylene oxide. (R═CH₃; X═Cl, [NO₃], [PF₆], [NTf₂]).

Epoxides include, but are not limited to, propylene oxide; 1,2-epoxyalkanes, such as 1,2-epoxy C₄-C₁₂ alkanes; 2,3-epoxyalkanes, such as 2,3-epoxy C₄-C₁₂ alkanes; and 3,4-epoxy-2-alkylcyclohexenes, such as 3,4-epoxy-2-methylcyclohexene. It is noted that the ranges of carbon atoms, as listed, include all ranges of carbon atoms within the respective ranges. For example, a C₄-C₁₂ range includes 4, 5, 6, 7, 8, 9, 10, 11 and 12 carbon atoms. In addition, within each range of three or more carbon atoms, linear and branched structures are included. It is also noted, that where appropriate, the general representations and specific representations of the above groups may also be substituted with additional chemical moieties, including, but not limited to, halogen atom, an alkyl group, an alkoxy group, a haloalkyl group, and a haloalkoxy group.

In a preferred embodiment, the epoxide represents, but is not limited to propylene oxide and ethylene oxide.

Acids, HnX, include, but are not limited to, HCl, HBr, HI, HF, HNO₃, HPF₆, HNTf₂, HClO₄, H₂SO₄, RSO₃H (a sulfonic acid; R is an alkyl group), H₃BO₃, and organic carboxylic acids lactic, salicylic, acetic, and formic acid, and phenols including picric acid.

In one embodiment of the invention, ILs were prepared by protonating 1-methylimidazole with the acids, HCl, H[NTf₂], HNO₃, HPF₆, followed by reaction with propylene oxide (Table 1). The reaction of 1-methylimidazole with HCl followed by addition of 1 equivalent of propylene oxide, in ethanol, at room temperature, resulted in the quantitative formation of the corresponding IL, I-Cl, containing the 1-(2-hydroxypropyl)-3-methylimidazolium cation, as monitored by ¹H NMR. With the other acids screened, HNO₃, H[NTf₂] and HPF₆, using 1 equivalent of propylene oxide, resulted in incomplete reaction. However, quantitative conversion to the respective ILs (I-[NO₃], I-[PF₆], I-[NTf₂]) was achieved when an excess (approx. 2 eq.) of propylene oxide was used.

TABLE 1
Reaction compositions investigated.

| | | | | % Con- |
|---|---|---|---|---|
| Base | | Acid | Epoxide | version^{a} |
| I-Cl | 1-methylimidazole | HCl | propylene oxide | >99 |
| I-[NO₃] | 1-methylimidazole | HNO₃ | propylene oxide | >95 |
| I-[PF₆] | 1-methylimidazole | HPF₆ | propylene oxide | >95 |
| I-[NTf₂] | 1-methylimidazole | HNTf₂ | propylene oxide | >99 |
| II-Cl | 1-butylimidazole | HCl | propylene oxide | >95 |
| III | 1-methylimidazole | HCl | 1,2-epoxydodecane | <8 |
| IV | 1,2-dimethylimidazole | HCl | propylene oxide | <5 |
| V | 1-decyl-2--methyl | HCl | propylene oxide | <3 |
| | imidazole | | | |

^{a}Product: reagent ratio estimated from ¹H NMR of crude reaction mixtures, after evaporation of solvents.

Removal of the reaction solvents (ethanol, and water) and excess propylene oxide allowed isolation of the ILs as clear, colorless liquids which were characterized by proton and carbon NMR, uv/vis spectroscopy. Relevant physical properties of the ionic liquids are given in Table 2.

TABLE 2
1-(2-Hydroxypropyl)-3-methylimidazolium salts isolated and their
properties. Glass transition (T_{g}) and melting point (Mₚ)
from onset position were determined by DSC from the first heating cycle,
after initially cooling samples to −100° C. Decomposition temperatures
(Tdec) were determined by TGA, heating at 10° C. min⁻¹ under
nitrogen.

| | | | | Water | | Viscocity |
|---|---|---|---|---|---|---|
| | T_{g} | Mp | T_{dec} | Content | Density | at 25° |
| IL | (° C.) | (° C.) | (° C.) | (wt %) | (g mL⁻¹) | (cPs) |
| I-Cl | −69.8 | — | 300 | 5.29^{a} | 1.15 | 1856 |
| I-[PF₆] | −88.4 | — | 325 | 2.22 | 1.11 | 319 |
| I-(NTf₂) | −67.6 | — | 425 | 0.95 | 1.57 | 342 |
| | | | | 6.11^{b} | | |
| I-[NO₃] | −79.3 | — | 320 | 0.11 | 1.17 | 502 |
| I-[BPh₄] | — | 136.5^{c} | ˜250 | — | — | — |

^{a}Water content after moderate drying, corresponds to 1:0.58 IL:H₂O,
^{b}After equilibration with an aqueous phase, water content corresponds to 1:1.57 IL:H20.
^{c}Enthalpy of melting, ΔHₘ = 173 kJ mol⁻¹.

The thermal behavior of the ILs was examined visually and by DSC. None of the ILs displayed a freezing transition on cooling to −15° C. in bulk, or to −150° C. (by DSC). In the bulk state, cooling overnight to −15° C. produced viscous non-crystalline materials. A glass transition was observed by DSC, in each case around −70 to 90° C., on heating from −150° C. with a 5° C. min⁻¹ gradient.

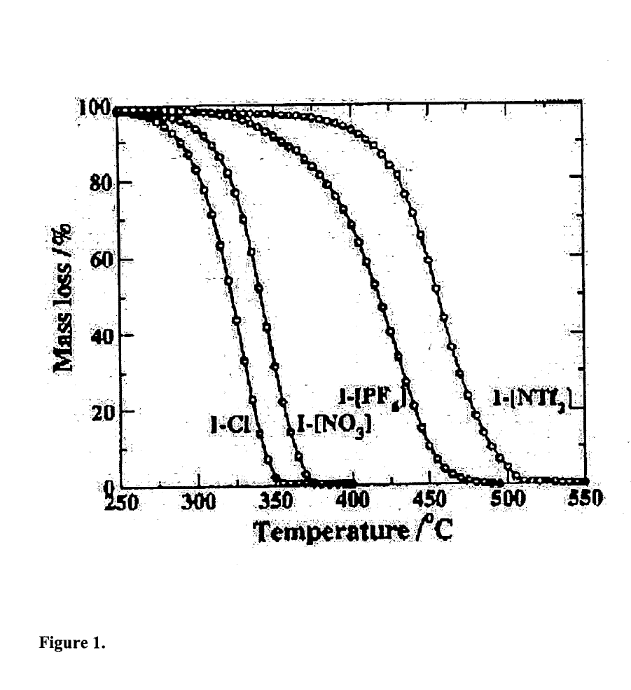

The thermal decomposition temperatures of these ILs, were determined using TGA, heating under an inert N₂ atmosphere at 10° C. min⁻¹. The thermal decomposition profiles are characteristic for ILs, the only mass loss below 300° C. was a small drop between 100-160° C. corresponding to removal of water and was consistent with the water-contents determined by Karl-Fisher titration. In each case, a subsequent single catastrophic weight loss is observed for decomposition of the IL on heating from 300-600° C. (see FIG. 1). The stability of each IL is dependent on the anion present, I-Cl was the least stable (T_{dec} approx. 300° C.), whereas I-[NTf₂] was the most stable (T_{dec}-approx. 425° C.). The relative stability of the ILs follows the order [Cl]⁻<[NO₃]⁻<[PF₆]⁻<[NTf₂]⁻, consistent with decomposition of the ILs via elimination of the imidazolium N-substituents, yielding volatile degradation products.

The reaction of 1-butylimidazole with 1 equivalent of propylene oxide resulted in mixed systems containing ca. 35-38% 1-(2-hydroxpropyl)-3-butylimidazolium cations, with the remainder protonated 1-butylimidazolium determined by ¹H NMR, similar to the reactions of propylene oxide with 1-methylimidazole/acid systems. Subsequent reaction with a further equivalent of propylene oxide resulted in complete conversion from 1-butylimidazole to 1-(2-hydroxypropyl)-3-butylimidazolium chloride (II-Cl), as a colorless liquid.

Treating an aqueous solution of I-Cl with aqueous HPF₆ resulted in the formation of a monophasic solution which was not characterized further, but directly indicates that I-[PF₆] is water soluble, and can not be prepared by metathesis in water, using the procedures commonly employed for other 1,3-dialkylimidazolium hexafluorophosphate salts. Metathesis of I-Cl with sodium tetraphenylborate in water resulted in the precipitation of I-[BPh4] as a white precipitate, which was recrystallized from ethanol/water to obtain crystals suitable for structure determination. The tetraphenylborate salt, characteristically, is much higher melting than the corresponding salts with other anions used to prepare ILs, and has a large enthalpy of melting. The single crystal x-ray structure of 1-[BPh4], shows formation of racemic crystals containing both cation isomers as a hydrogen-bonded dimer.

The miscibility of I-Cl and I-[NO₃] was determined with a range of molecular solvents. The ILs were completely miscible with water, DMSO, and acetonitrile, and formed biphasic systems with benzene, hexane, and diethylether, and also unexpectedly with dichloromethane and acetone. Biphase formation with the latter two solvents was most unexpected, since from experimental observation and the literature,¹⁴ all ILs have been miscible with both dichloromethane and acetone. Addition of the hydroxyl functionality may be sufficient to explain the immiscibility with dichloromethane (a relatively polar, yet hydrophobic liquid), but the formation of a biphase with acetone (a polar, hydrophilic liquid) cannot be readily explained at this point.

As a result of addition of the hydroxyl-function to the cation, the ILs prepared here are significantly more hydrophilic then corresponding conventional dialkylimidazolium systems. Both I-Cl and 1-[NO₃] were hydroscopic, absorbing water when exposed to a moist atmosphere. Unusually, this hexafluorophosphate-containing IL, I-[PF₆], was also water soluble. Whereas some organic hexafluorophosphate salts with small cations (fox example, ammonium, and dimethylimidazolium) are water miscible, most IL examples are only sparingly miscible with water, and are the principle examples of ‘hydrophobic’ ILs. I-[NTf₂] formed a biphase when contacted with water, in common with other [NTf₂]-containing ILs. However, the hydrophilicity of I-[NTf₂] in comparison with the corresponding 1,3-dialkylimidazolium salts, is much higher. After drying in vacuo, I-(NTf₂) was determined to contain 0.95 wt % water (0.22 mole equivalents), however after contacting with water, the equilibrium water content was 6.11 wt % (1.5 mole equivalents).

None of the remaining systems screened (III-V, combinations screened, were, 1,2-dimethylimidazole and 1-decyl-2-methylimidazole with propylene epoxide, and 1-methylimidazole with 1,2-epoxydodecane, all using hydrochloric acid and the conditions described in the experimental section for preparation of I-Cl, see Table 1), resulted in sufficient conversion of the initial imidazole to be effective for the synthesis of ILs as bulk solvents for further studies under the reaction conditions used, and the products were not isolated.

The reactions appear to be amenable to the use of a variety of acids to provide the anion of the resulting IL, thus allowing direct synthesis of a range of ILs with differing properties, without requiring subsequent metathesis steps.

It has also been demonstrated that the anion of these ILs can be exchanged using established metathetical routes, as illustrated by the conversion of I-Cl to I-[NTf₂] and to I-[BPh4].

It is possible to directly prepare chiral ILs using this procedure, utilizing the range of chiral epoxides that are becoming more readily available with recent advances in catalytic chiral expoxidation reactions.¹⁵

The hydrophilicity afforded by the hydroxyl-group may be advantageous for stabilizing enzymatic catalyst systems in non-aqueous IL environments, and may also provide new applications in metal complexation and partitioning. In these ILs, both hydrogen-bond donating and accepting positions (—OH, and —OH respectively) have been introduced into the cationic portion, and a comparison with ether-functionalized ILs containing only hydrogen-bond acceptor sites could be informative.

### EXAMPLES

Having generally described this invention, a further understanding can be obtained by reference to certain specific examples, which are provided herein for purposes of illustration only, and are not intended to be limiting, unless otherwise specified.

All reagents were used as received.

Bis(trifluoromethanesulfonyl)amide (neat), lithium bis(trifluoromethanesulfonyl)amide, and hexafluorophosphoric acid (66 wt % solution in water) were gifts from Rhodia (Cranbury, N.J.), 3M (St. Paul, Minn.), and Ozark Fluorine Specialties (Folcroft, Pa.), respectively. 1-Methylimidazole and propylene oxide were purchased from Aldrich (St. Louis, Mo.). Proton (¹H) and ¹³C NMR spectra were recorded on Bruker AM360 spectrometer in DMSO-d₆. Peak positions are reported relative to DMSO-d₆ (δ_{H}=2.50 ppm, δ_{c} 40.45 ppm). Melting points and glass transition temperatures were determined by differential scanning calorimetry (TA 2620 DSC equipped with cryostat cooling, 5-20 mg samples, 5° C. min⁻¹ heating and cooling rates). Thermal decomposition profiles were collected by thermogravimetric analysis (TA 2950 TGA, 10° C. min⁻¹ heating rate under nitrogen).

Caution: propylene oxide is a volatile, flammable, carcinogenic liquid (bp 34° C.) that can react violently with both strong acids and bases. In all studies, care was taken to ensure that the alkylimidazole bases and acid reagents were thoroughly reacted and neutralized prior to introduction of the epoxide reagents into the reaction vessels. At all times, reaction temperatures were maintained at, or below 25° C., and the reactions were carried out in a well ventilated fumehood.

### Example 1

### 1-(2-Hydroxypropyl)-3-methylimidazolium chloride (I-Cl)

To a stirred solution of 1-methylimidazole (20 mL, 20.6 g, 0.25 mol) in abs. ethanol (40 mL) at room temperature, was carefully added concentrated hydrochloric acid (21 mL, 0.255 mol). Care: neutralization of base with a strong acid, highly exothermic. After addition of acid, the reaction mixture was cooled to room temperature, and propylene oxide (18 mL, 15 g, 0.26 mol) was added dropwise with stirring, while maintaining the temperature at 25° C. The reaction vessel was then sealed and stirred at room temperature for 24-48 h. The solvent was removed under reduced pressure with heating at 70° C., followed by heating under high vacuum, to yield a colorless liquid that became more viscous upon extensive drying, but did not solidify. ¹H NMR (360 MHz, DMSO-d₆) δ 1.05 (3H, d, CH₃), 3.57 (2.2H, H₂O), 2.88 (3H, s, N—CH₃), 4.0 (2H, m), 4.26 (1H, dd, AA′B NCH₂CH(OH)—), 5.50 (1H, d, C(OH)), 7.74, 7.75 (2H, 2xs, C(4,5)-H), 9.24 (1H, s, C(2)-H). ¹³C (90.5 MHz, DMSO-d₆) δ 20.32 (CH₃), 35.83 (N—CH₃), 55.54 (N—CH₂), 64.88 (CH(OH)), 123.16 (C(4,5)), 137.00 (C(2)).

¹H NMR (360 MHz, D₂O) δ 1.26 (3H, d, J=6.3 Hz, CH₃), 3.94 (3H, s, N—CH₃), 4.12 (1H, dd, J₁=7.7, J₂=13.8), 4.20 (1H, m, CH(OH)), 4.34 (1H, dd, J₁=13.8, J₂=2.7), 7.487 (1H, d, J=1.7 Hz, C(4)-H), 7.521 (1H, d, J=1.8 Hz, C(5)-H), no C(2)-H observed due to ¹H/²D exchange. ¹³C NMR (90.5 MHz, D₂O) δ 21.70 (CH₃), 38.48 (N—CH₃), 58.41 (N—CH₂), 68.59 (CH(OH)), 125.69, 126.16 (C(4,5)), no C(2) signal was observed.

¹H NMR (360 MHz, neat) δ 0.81 (311, d, CH₃), 3.65 (3H, s, N—CH₃), 3.80, 3.90 (3H, 4.11 3xm, AA′B, NCH₂CH(OH)—), 4.25, (s, 2.2H, H₂O), 5.34 (1H, b, C(OH)), 7.50 (2H, 2xs, C(4,5)-H), 8.82 (1H, s, C(2)-H). ¹³C NMR (90.5 MHz, neat) δ 20.62 (CH₃), 36.82 (N—CH₃), 56.27 (N—CH₂), 66.00 (CH(OH)), 123.68, 123.80 (C(4,5)), 137.34 (C(2)).

### Example 2

### 1-(2-Hydroxypropyl)-3-methylimidazolium bis(trifyl)amide (I-[NTf₂])

I-[NTf₂] was prepared using the same procedure as I-Cl using bis(trifluoromethanesulfonyl)amide (HNTf₂, 70 g, 0.25 mol). After reaction of the 1:1:1 mixture for 24 h., ¹H NMR indicated a mixture containing 3:1 product starting material. A further aliquot of propylene oxide (10 mL, 0.14 mol) was added and stirred at room temperature for a further 24 h. Evaporation of the solvent and excess propylene oxide yielded I-NTf₂ as a hydrophobic colorless liquid. ¹H NMR (360 MHz, DMSO-d₆) δ 1.10 (1H, d, J=5.9 Hz, —CH₃), 3.86 (3H, s, N—CH₃), 3.95 (2H, m), 4.17 (1H, m) [AA′B, NCH₂CH(OH)—], 5.20 (1H, d, J=3.6 Hz, C—OH), 7.62, 7.63 (2H, 2xs, C(4,5)-H), 9.00, (1H, s, C(2)-H). ¹³C NMR (90.5 MHz, DMSO-d₆) δ 20.26 (CH₃), 35.76 (N—CH₃), 55.89 (N—CH₂), 64.93 (CH (OH)), 119.69 (q, J_{C—F}=343 Hz, CF₃), 123.21, 123.22 (C(4,5)), 137.07 (C(2)).

### Example 3

Preparation of I-[NTf₂] by Metathesis from I-Cl.

To a stirred solution of I-Cl in water, was added a solution of LiNTf₂ in water, resulting in immediate biphase formation. The lower, IL phase was collected, washed with water, and dried under reduced pressure with heating at 70° C. to yield a colorless liquid. Analysis and appearance were identical to the product prepared by the direct method.

### Example 4

### 1-(2-Hydroxypropyl)-3-methylimidazolium hexafluorophosphate (I-[Pf₆])

I-[PF₆] was prepared by reaction of 1-methylimidazole with HPF₆ (37 mL, 0.25 mol, 66 wt % solution in water) and propylene oxide in ethanol, following the procedure described for I-C1. Removal of the volatile solvents under reduced pressure, followed by final drying in vacuo at 70° C. gave a colorless liquid. ¹H NMR (360 MHz, DMSO-d₆) δ 1.08 (3H, d, J=5.5 Hz, —CH₃), 3.83 (s, 3H, N—CH₃), 3.94 (2H, m), 4.17 (1H, m) [AA′B system, NCH₂CH(OH)—], 7.58, 5.59 (2H, 2xs, C(4/5)-H), 8.92 (1H, s, C(2)-H). ¹³C NMR (90.5 MHz, DMSO-d₆) δ 20.50 (—CH₃), 35.97 (N—CH₃), 56.03 (N—CH₂), 65.16 (CH(OH)), 123.36, 123.42 (C(4/5)), 137.11 (C(2)).

### Example 5

### 1-(2-Hydroxypropyl)-3-methylimidazolium nitrate (I-[NO3])

I-[NO₃] was prepared by reaction of 1-methylimidazole (20 mL, 20.6 g, 0.25 mol) with conc. nitric acid (16.5 mL, 0.25 mol) and propylene oxide (30 mL, 24.9 g, 0.43 mol) in ethanol (40 mL), following the procedure described for I-C1. Removal of the volatile solvents under reduced pressure, followed by final drying in vacuo at 70° C. gave a colorless liquid. ¹H NMR (360 MHz, DMSO-d₆) δ 1.07 (3H, d, J=5.5 Hz, —CH₃), 3.85 (s, 3H, N—CH₃), 3.93 (2H, m), 4.20 (1H, m) [AA′B system, NCH₂CH(OH)—], 5.50 (1H, b, C—OH), 7.69 (2H, s, C(4/5)-H), 9.08 (1H, s, C(2)-H). ¹³C NMR (90.5 MHz, DMSO-d₆) δ 20.31 (—CH₃), 35.66 (N—CH₃), 55.68 (N—CH₂), 64.80 (CH(OH)), 123.12, 123.19 (C(4/5)), 137.02 (C(2)).

### Example 6

### 1-(2-Hydroxyropyl)-3-methylimidazolium tetraphenylborate (I-[BPh₄])

Crystals of I-[BPh4] were prepared by metathesis of I-Cl in water with sodium tetraphenylborate. The white, insoluble precipitate formed was collected by filtration, air dried and recrystallized from methanol/water as large colorless blocks. Mp 138° C., ¹H NMR (360 MHz, DMSO-d₆) δ 1.08 (3H, d, J=5.5 Hz, —CH₃), 3.82 (s, 3H, N—CH₃), 3.91 (2H, m), 4.14 (1H, m) (AA′B system, NCH₂CH(OH)—], 5.19 (1H, b, J=4.3 Hz, C—OH), 6.80 (4H, t, α-CH), 6.93 (8H, t, β-CH), 7.18 (8H, m, y-CH), 7.63 (2H, s, C(4/5)-H), 8.98 (1H, s, C(2)-H).

### Example 7

### 1-(2-Hydroxypropyl)-3-butylimidazolium chloride (II)

Reaction of 1-butylimidazole (52.9 g, 90 wt % in water, 0.25 mol), concentrated hydrochloric acid (21 mL, 0.255 mol) and propylene oxide (18 mL, 15 g, 0.26 mol)in ethanol following the procedure for I-C1, resulted in a colorless liquid containing 3:2 product: starting material based on ¹H NMR. A further portion of propylene oxide (18 mL, 0.26 mol) was added to the crude reaction mixture and stirred at room temperature for 24 h., and unreacted propylene oxide was removed under reduced pressure, and the in vacuo with heating at 70° C. to yield II as a colorless liquid. ¹H NMR (360 MHz, DMSOd₆) δ 0.85 (3H, CH₃), 1.06 (3 H, d, CH₃), 1.21 (m, 2H), 1.75 (m, 2H), 3.93 (2H, t), 4.3 (1H, dd), 4.20 (1H, dd), 4.27 (1H, dd.), 5.52 (1H, d, COH), 7.85 (2H, C(4,5)H), 9.50 (1H, C(2)H).

Obviously, numerous modifications and variations of the present invention are possible in light of the above teachings. It is therefore to be understood that within the scope of the appended claims, the invention may be practiced otherwise than as specifically described herein. All references cited herein, either directly or by footnote, are hereby incorporated in their entirety by reference.

References

1 Ionic Liquids in Synthesis, ed. P. Wasserscheid and T. Welton, VCH-Wiley: Weinheim, 2002; Ionic Liquids; Industrial Applications for Green Chemistry, ed. R. D. Rogers and K. R. Seddon, ACS Symposium Series 818, American Chemical Society: Washington DC, 2002

2 T. Welton, Chem. Rev., 1999, 99, 2071; J. D. Holbrey and K. R. Seddon, Clean Prod. Proc., 1999, 1, 223; P. Wasserscheid and W. Keim, Angew. Chem. Int. Ed., 2000, 39, 3772; R. Sheldon, Chem. Commun., 2001, 2399; C. M. Gordon, Appl. Catal. A, 2001, 222, 101; H. Olivier-Bourbigou and L. Magna, J. Mol. Catal. A: Chem., 2002, 182-183, 419; J. Dupont, R. F. de Souza and P. A. Z. Suarez, Chem. Rev., 2002, 102, 3667.

3 A. P. Abbott, G. Capper, D. L. Davies, H. L. Monroe, R. K. Rasheed and V. Tambyrajah, Chem. Commun., 2001, 2010.

4 M. B. Turner, S. K. Spear, J. G. Huddleston, J. D. Holbrey, R. D. Rogers, Green Chem., 2003, DOI: 10.1039/b302570e.

5 P. Bonhôte, A. P. Dias, N. Papageorgiou, K. Kalyanasundaram and M. Grätzel, Inorg. Chem., 1996, 35, 1168.

6 J. D. Holbrey, W. M. Reichert, I. Tkatchenko, E. Bouajila, O. Walter, I. Tommasi and R. D. Rogers, Chem. Commun., 2003, 28.

7 A. J. Ardeuengo III, U.S. Pat. No. 5,077,414, Dec. 31, 1991

8 G. Cooper and W. J. Wilson, J. Chem. Soc., Perkin Trans. 1, 1976, 5, 545.

9 A. F. Aslanov, N. I. Korotkikh, O. P. Shvaika, Chem. Het. Compounds, 1996, N8(250) 1062.

10 F. Ricciardi, W. A. Romanchick and M. M. Jouille, J. Polym. Sci., 1983, 21, 1475.

11 P. L. Arnold, A. C. Scarisbrick, A. J. Blake and C. Wilson, Chem. Commun., 2001, 2340.

12 H. Glas and W. R. Thiel, Tetrahedron Letts., 1998, 39, 5509.

13 H. Glas, E. Herdtweck, M. Spiegler, A. K. Pleier and W. R. Thiel, J. Organomet. Chem., 2001, 626, 100.

14 J. D. Holbrey and K. R. Seddon, J. Chem, Soc., Dalton Trans., 1999, 2133.

15 E. N. Jacobsen, in Catalytic Asymmetric Synthesis, Ed. I. Ojima, VCH, New York, 1993, 159.

1: An ionic liquid represented by formula (1)
[R′₁CH(OH)CH₂]N R′ₙX (1),
wherein [R′₁CH(OH)CH₂]N R′ₙ represents a cation and X represents an anion, and
R′ represents an alkyl group, an alkenyl group, an alkynyl group, a cycloalkyl group, an alkylcarbonyl alkyl group, an alkoxy group, haloalkyl group, a haloalkoxy group, a alkenyloxy group, a alkynyloxy group, a cycloalkyloxy group, or an aryl group.

2: The ionic liquid of claim 1, wherein the cation is selected from a low-symmetry quaternized, alkyl-substituted aliphatic or heterocyclic cation.

3: The ionic liquid of claim 2, wherein the cation is a low-symmetry quaternized, alkyl-substituted heterocyclic cation, and wherein the heterocyclic group contains one or more substituted heteroatoms.

4: The ionic liquid of claim 3, wherein the ionic liquid contains secondary hydroxyl functionality on one or more of the hetero-atom substituents.

5: The ionic liquid of claim 1, wherein the cation is selected from a substituted imidazolium cation, a substituted pyridinium cation, a substituted pyrrolinidium cation or a substituted guanidinium cation.

6: The ionic liquid of claim 2, wherein the anion is selected from a halide, a phosphate, a nitrate, a borate, an amide, a sulfonate, a sulfate, an imide, a tosylate, an antimonite or a carboxylate.

7: The ionic liquid of claim 5, wherein the anion is selected from a halide, a phosphate, a nitrate, a borate, an amide, a sulfonate, a sulfate, an imide, a tosylate, an antimonite or a carboxylate.

8: The ionic liquid of claim 7, wherein the anion is selected from chloride, bromide, iodide, fluoride, nitrate, triphenylborate, tetrafluoroborate, trifluoromethyltrifluoroborate, bis[oxalate(2-)]-borate, bis[salicylato(2-)]-borate, hexafluorophosphate, tris(perfluoroethyl)trifluorophosphate, tris(pentafluoroethyl)trifluorophosphate, methylsulfate, ethylsulfate, trifluoromethanesulfonate, trifluoromethylsulfonate, bis(trifyl)amide, bis(trifluoromethyl)imide, or bis(trifluoromethylsulfonyl)imide.

9: The ionic liquid of claim 1, wherein the ionic liquid is a 1-(2-hydroxypropyl)-3-methylimidazolium salt.

10: The ionic liquid of claim 9, wherein the ionic liquid is selected from 1-(2-hydroxypropyl)-3-methylimidazolium chloride, 1-(2-hydroxypropyl)-3-methylimidazolium bis (trifyl) imide, 1-(2-hydroxypropyl)-3-methylimidazolium hexafluorophosphate, 1-(2-hydroxypropyl)-3-methylimidazolium nitrate, 1-(2-hydroxypropyl)-3-methylimidazolium tetraphenylborate or 1-(2-hydroxypropyl)-3-butylimidazolium chloride.

11: A composition comprising the ionic liquid of claim 1, and one or more solvents.

12: A composition comprising the ionic liquid of claim 9, and one or more solvents.

13: The composition of claim 12, wherein the ionic liquid is selected from 1-(2-hydroxypropyl)-3-methylimidazolium chloride, 1-(2-hydroxypropyl)-3-methylimidazolium bis(trifyl)imide, 1-(2-hydroxypropyl)-3-methylimidazolium hexafluorophosphate, 1-(2-hydroxypropyl)-3-methylimidazolium nitrate, 1-(2-hydroxypropyl)-3-methylimidazolium tetraphenylborate or 1-(2-hydroxypropyl)-3-butylimidazolium chloride.

14: A method for preparing an ionic liquid, comprising reacting an epoxide with a N-protonated nitrogen base to form the ionic liquid.

15: The method of claim 14, wherein the epoxide is selected from propylene oxide, a 1,2-epoxyalkanes, a 2,3-epoxyalkanes or 3,4-epoxy-2-alkylcyclohexene.

16: The method of claim 15, wherein the N-protonated nitrogen base is selected from a substituted or unsubstituted imidazolium cation, a substituted or unsubstituted pyridinium cation, a substituted or unsubstituted pyrrolinidium cation, or a substituted or unsubstituted guanidinium cation.

17: The method of claim 14, wherein the N-protonated nitrogen base is prepared in situ by neutralization with an acid.

18: The method of claim 17, wherein the acid is selected from HCl, HBr, HI, HF, HNO₃, HPF₆, HNTf₂, HClO₄, H₂SO₄, RSO₃H (a sulfonic acid) or H₃BO₃.

19: The method of claim 16, wherein the N-protonated nitrogen base is prepared in situ by neutralization with an acid.

20: The method of claim 19, wherein the acid is selected from HCl, HBr, HI, HF, HNO₃, HPF₆, HNTf₂, HClO₄, H₂SO₄, RSO₃H (a sulfonic acid) or H₃BO₃.

21: The method of claim 14, further comprising exchanging the anion of the ionic liquid by a metathesis reaction.

22: The method of claim 16, further comprising exchanging the anion of the ionic liquid by a metathesis reaction.

23: The ionic liquid of claim 1, wherein the ionic liquid is a 1-(2-hydroxypropyl)-3-alkylimidazolium salt.
